(19) United States
(12) Patent Application Publication
(10) Pub. No.: US 2002/0081182 A1
(43) Pub. Date: Jun. 27, 2002

(54) Low rise loading trailer

(76) Inventor: Jeffrey L. Harris, Toledo, OH (US)

Correspondence Address: PURDUE LAW OFFICES, 2735 N. HOLLAND-SYLVANIA ROAD, SUITE B-2, TOLDEO, OH, 43615

(21) Appl. No.: 09/496,857

(22) Filed: Feb. 2, 2000

(51) Int. Cl. B60P 1/28; B60P 1/16

(52) U.S. Cl. 414/477; 414/480; 414/482

(57) ABSTRACT

An improved trailer comprising a drawbar, a deck connected to the drawbar by a pivot connection, an axle carriage and an actuator. The axle carriage includes at least two skids and the deck is provided with skid runners for supporting the deck on the axle carriage skids. The actuator is operably connected to cause movement of the axle carriage, relative to the deck, between a first, road position and a second, load position in which the deck is pivoted to a low rise, loading position. The deck may comprise a main deck and a loading deck with the main deck connected to the drawbar by a pivot connection near the front of the trailer. The main deck and the loading deck include skid runners for supporting the deck on the axle carriage skids. The main deck is connected to the loading deck by a pivot connection adjacent the rear of the trailer. An actuator is operably connected to cause movement of the axle carriage, relative to the deck, between a first, road position and a second, load position in which a rear portion of the trailer rests on the ground. A second actuator is operably connected to cause relative movement between the main deck and the loading deck between a first, road position, where their upper surfaces are substantially co-planar, and a second, loading position where a forward portion of the loading deck is resting on the ground. A rear gate is connected by a pivot connection to the rear of the main deck and the loading deck, and a third actuator is operably connected to cause relative movement between the gate and the deck between a first, up, road position, a second position where a lower surface of the gate rests on the ground, and a third position in which an upper surface of the deck is substantially co-planar with upper surfaces of the deck.

### BACKGROUND OF THE INVENTION

1. Field of the Invention.

The present invention relates generally to trailers and especially to trailers having decks which can be tilted to a very low loading angle or to a virtually zero grade for loading a payload, and which can be righted or raised to trail the load.

2. Description of the Prior Art

During a search directed to the subject matter of the instant invention, the following patents were noted: U.S. Pat. No.4,054,218 (Mackey) entitled Tiltable Trailer; U.S. Pat. No.4,125,198 (Landoll) entitled Trailer Having Shiftable Undercarriage; U.S. Pat. No.4,231,710 (Landoll) entitled Tiltable Trailer Having Movable Undercarriage; U.S. Pat. No.4,492,507 (Landoll, et al.) entitled Actuator for Shiftable Undercarriage of Tiltable Trailer; U.S. Pat. No.4,568,235 (Bills, Jr.) entitled Low Angle Tilt Trailer; U.S. Pat. No. 4,702,662 (Marlett) entitled Trailer; U.S. Pat. No. 4,746,261 (Landoll, et al.) entitled Self-loading Tilt-bed Trailer Having Transverse Bed Realignment Means; U.S. Pat. No.4,948,155 (Smith, et al.) entitled Apparatus for Extending and Retracting the Rear Wheels of a Trailer; U.S. Pat. No. 5,013,056 (Landoll, et al.) entitled Low Load Angle Step Deck Trailer Having Shiftable Undercarriage; U.S. Pat. No.5,137,414 (Sloan, et al.) entitled Translatable Tilt-bed Trailer Apparatus; U.S. Pat. No. 5,324,160 (Smith) entitled Tiltable Trailer for Loading, Unloading and Transporting Containers; U.S. Pat. No.5,667,231 (Dierks, et al.) entitled Trailer; U.S. Pat. No. 5,678,978 (Markham) entitled Apparatus for a Tiltable Rolloff Trailer Having a Displacable Frame; U.S. Pat. No.5,775,711 (Floe) entitled Trailer Structure; U.S. Pat. No. 5,775,868 (Mann) entitled Movable-deck Trailer; U.S. Pat. No. 5,782,490 (Kendall, et al.) entitled Track Wheeled Trailer; U.S. Pat. No. 5,921,742 (Gearhart) entitled Articulating Roll-off Trailer; U.S. Pat. No. 5,967,733 (Cash) entitled Hydraulic Tilt Trailer; and U.S. Pat. No. 5,975,828 (Weldy) entitled Trailer Tilt System.

### SUMMARY OF THE INVENTION

The present invention is based upon the discovery of an improved trailer comprising a drawbar, a deck connected to the drawbar, an axle carriage and an actuator. The axle carriage includes at least two skids and the deck is provided with skid runners for supporting the deck on the axle carriage skids, in sliding relationship therewith. The deck is connected to the drawbar by a pivot connection The actuator comprises one or more linear actuators connected between the deck and the axle carriage. The actuator is operable to cause movement of the axle carriage, relative to the deck, between a first, road position where the deck is supported over the axle carriage, so that the trailer and a payload can be towed, and a second, load position in which the axle carriage is forward of the pivot connection between the deck and the drawbar, and the deck pivots to a low rise, loading position. The deck may comprise a main deck and a loading deck. The main deck is connected to the drawbar by a pivot connection near the forward end of the main deck. The main deck includes skid runners for supporting the deck on the axle carriage skids and is connected to the loading deck by a pivot connection adjacent the rear of the deck. The loading deck includes skid runners for supporting the it on the axle carriage skids. In this embodiment, a first actuator is operable to cause movement of the axle carriage, relative to the deck, between a first, road position where the main deck and the loading deck are supported over the axle carriage, so that the trailer and a payload can be towed, and a second, load position in which the axle carriage is forward of the drawbar and main deck pivot connection, and the main deck and the loading deck pivot to a low rise load position with a rear portion of the main deck resting on the ground. There is provided a second actuator which is operable to cause relative movement between the main deck and the loading deck between a first, road position, where the main deck and the loading deck are substantially co-planar and a second, loading position where the forward portion of the loading deck is resting on the ground. The trailer further comprises a rear gate which is connected by a pivot connection to the rear of the trailer, and a third actuator operable to cause relative movement between the gate and the deck between a first, up, road position, a second, position where a lower surface of the gate rests on the ground, and a third position in which an upper surface of the gate is substantially co-planar with upper surfaces of the main deck and the loading deck. Preferably, the gate is wedge shaped.

Accordingly, it is an object of the present invention to provide an improved trailer with a deck that is connected to a drawbar by a pivot connection, so that the deck can pivot from a first, road position to a second, tilted, load position for easy loading and unloading.

It is another object of the present invention to provide such a trailer with an axle carriage and an actuator for moving it, relative to the deck, between a first, road position in which the deck of the trailer is supported over the axle carriage and a second, tilt position where it is no longer supports the rear portion of the trailer deck so that the deck pivots about the pivot connection until the rear portion of the deck rests on the ground, and the deck is supported at a very low loading angle.

It is a further object of the invention to provide such a trailer where the actuator can position the axle carriage in a plurality of road positions so that the tongue or drawbar weight of the trailer is optimized.

It is a very important object of this invention to provide such a trailer with a main deck connected to the drawbar by a pivot connection, a loading deck with its rear portion connected to the rear of the main deck by a pivot connection and a second actuator for lowering the front of the loading deck to the ground.

These, and other objects and advantages of trailers according to the present invention will be fully appreciated by those skilled in the art upon reviewing the disclosures herein.

### BREF DESCRIPTION OF THE SEVERAL VIEWS OF THE DRAWING

FIG. 1 is a side view of a first embodiment of a trailer according to the invention with an axle carriage and a deck in a first, road position.

FIG. 2 is a bottom view of the trailer illustrated in FIG. 1.

FIG. 3 is a side view of the trailer shown in FIG. 1 with the axle carriage and the deck in a second, load position and the rear portion of the trailer deck lowered.

FIG. 4 is bottom view of the trailer illustrated in FIG. 3.

FIG. 5 is a cross-sectional view taken along the line 5-5 in FIG. 2.

FIG. 6 is a cross-sectional view taken along the line 6-6 in FIG. 4.

FIG. 7 is a side view of a second embodiment of a trailer according to the invention, with an axle carriage, a main deck and a loading deck, all in a first, road position.

FIG. 8 is a bottom view of the trailer illustrated in FIG. 7.

FIG. 9 is a side view of the trailer shown in FIG. 7 with the axle carriage, the main deck and a gate deck in a second, load position and the loading deck of the trailer deck resting on the ground.

FIG. 10 is bottom view of the trailer illustrated in FIG. 9.

FIG. 11 is a cross-sectional view of the actuator taken along the lines 11-11 of FIG. 8.

FIG. 12 is a side view of the trailer shown in FIG. 7 with the axle carriage in second, load position, the loading deck in a first, road position and the gate deck in a third, extended load position wherein the upper surfaces of the main deck and the loading deck are substantially co-planar with an upper surface of the tailgate.

FIG. 13 is a cross sectional view taken along the lines 13-13 of FIG. 8.

### DETAILED DESCRIPTION OF THE PREFERRED EMBODIMENTS

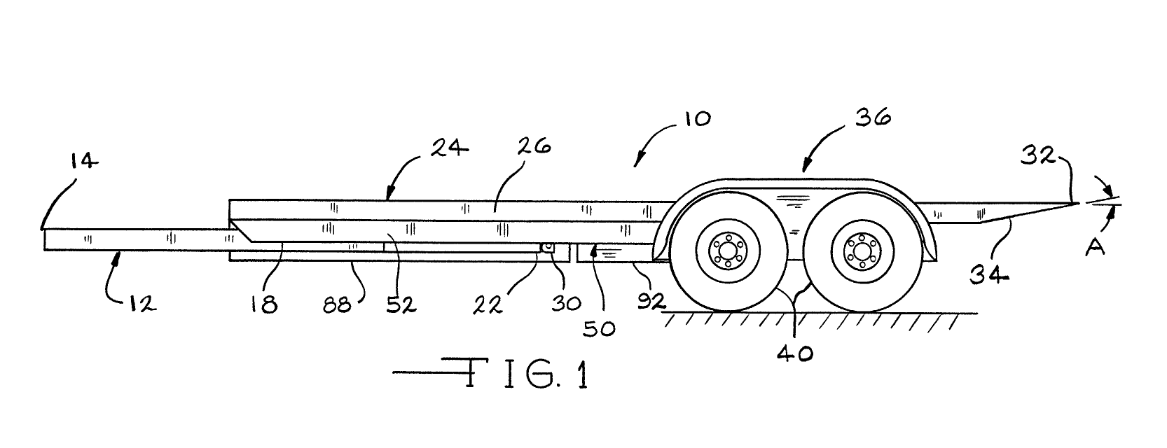

A trailer according to one embodiment of the present invention is indicated generally at 10 in FIGS. 1, 2, 3 and 4. The trailer 10 comprises a drawbar 12 having a first end 14 which is connected to a towing vehicle (not shown) in any suitable manner. The drawbar 12 comprises a center bar 16 and two side bars 18. An end 20 of the center bar 16 and ends 22 of the side bars 18 are connected to a deck indicated generally at 24.

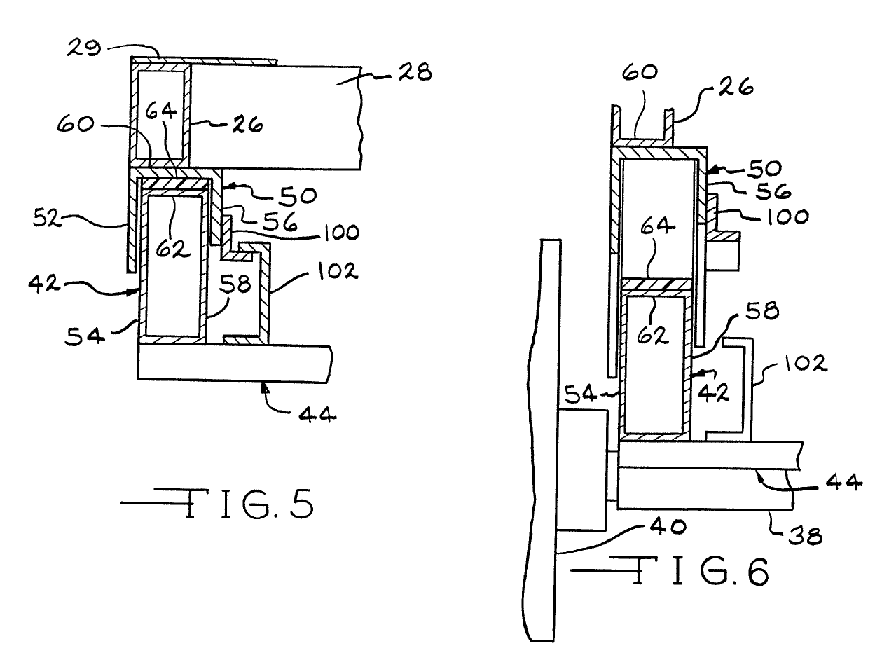

The deck 24 includes a frame comprising side rails 26 and cross rails 28. The rails 26 and 28 are preferably made of steel channel members which are welded together where they meet. The deck 24 can have any suitable configuration and, in this embodiment, constitutes a generally rectangularly shaped unitary structure comprising side rails 26 and cross rails 28 which constitute a deck frame, and a deck bed 29 (shown in FIG. 5) secured to the frame by welding or other suitable means. Diamond steel plate is a preferred material for the deck bed 29.

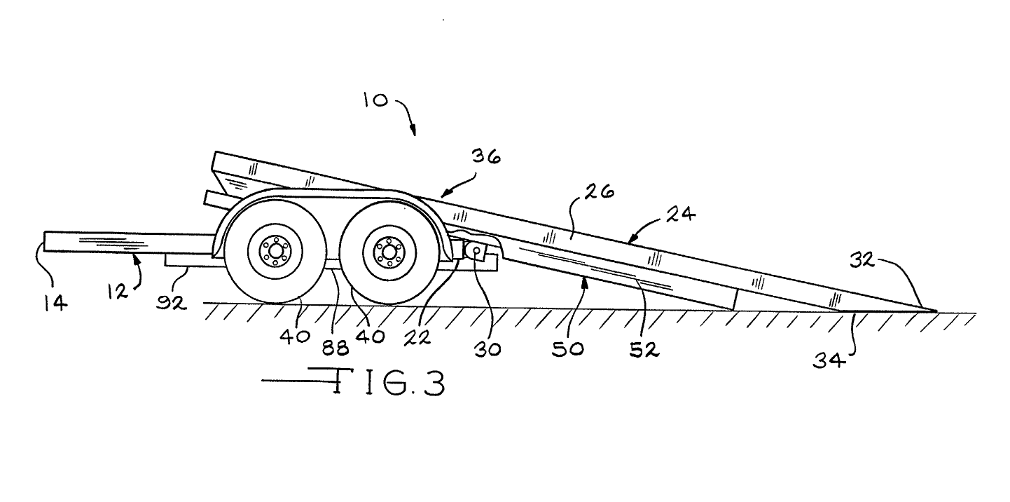

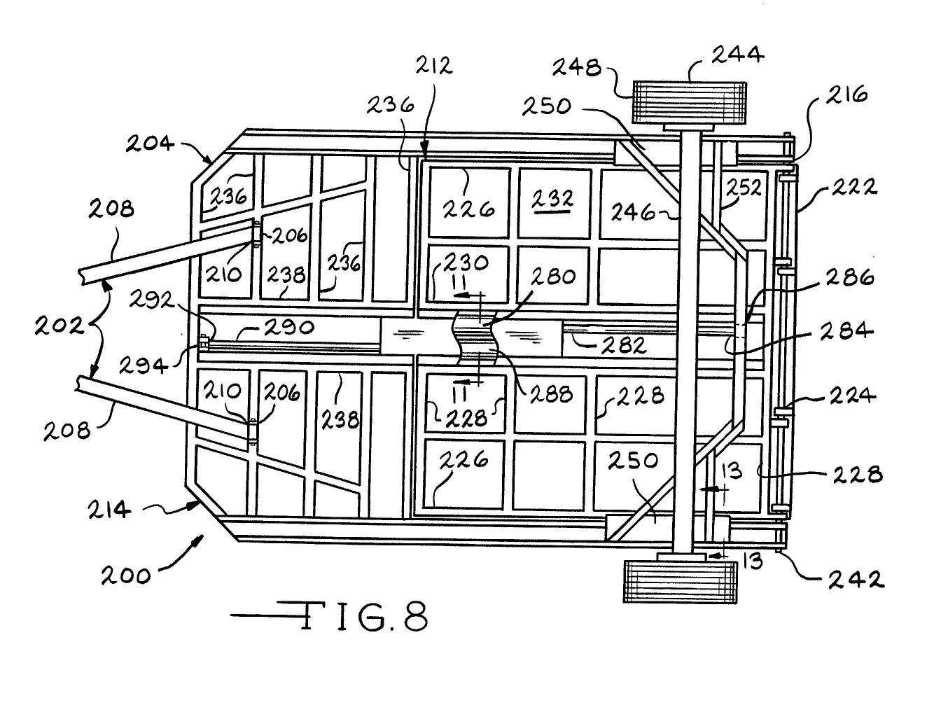

The drawbar 12 and, specifically, the ends 20 and 22 of the center bar 16 and side bars 18 are connected to the deck 24 and. specifically, to a cross rail 28, by pivot connections 30. Thus, under certain circumstances, the deck 24 can pivot, relative to the drawbar 12, between a first, road position shown in FIG. 1, to a second, load position illustrated in FIG. 3. In the first, road position, a rear edge 32 of the deck 24 is supported above the ground, as shown in FIG. 1 and two of the cross rails 28 of the deck 24 rest on the center bar 16 and the side bars 18 of the drawbar 12. In the second, load position, a lower surface 34 of the deck 24, adjacent to the rear edge 32 of the deck 24, is resting on the ground, as shown in FIG. 3 and the deck 24 is supported on the drawbar 12 at the pivot connections 30. The lower surface 34 forms a small included angle with the deck bed 29 which forms the upper surface of the deck 24, and that angle is equal to the angle labeled “A” in FIG. 1. This angle should be made to correspond with the angle formed between the deck bed 29 and the ground when the deck 24 is in the second, load position (FIG. 3) so that the lower surface 34 rests firmly on the ground in that case. In an eighteen foot trailer corresponding with the trailer 10, with the pivot connections 30 located about four feet from the front of the deck, the load angle of the deck bed is about seven degrees. In the embodiment described below with reference to FIGS. 7 through 12, the trailer deck is closer to the ground for a given axle chassis height, and even lower load angles are achieved in that case.

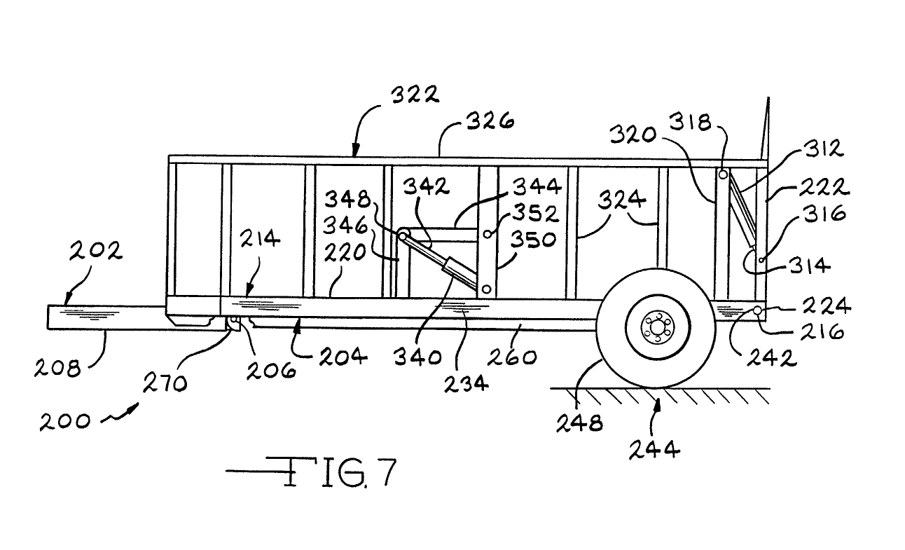

The deck 24 is supported on an axle carriage, indicated generally at 36. The axle carriage 36 illustrated in FIGS. 1 through 4 includes a tandem axle chassis, although an axle chassis with any number of axles may be provided in an axle carriage suitable for use in a trailer according to the invention. The axle chassis comprises a pair of axles 38 with a pair of wheels 40 supported on each. The axle carriage 36 further comprises a pair of skids 42 (see especially FIGS. 5 and 6) which are secured, as by welding or the like, to the axle carriage 36.

The skids 42 extend longitudinally of the trailer 10 and, preferably, as shown, are a little longer than the distance between the axles 38. The length of the skids can be varied so long as they provide adequate support for the deck 24. The axle carriage 36 further comprises a frame, indicated generally at 44, which is secured by welding or the like to the axle chassis or, as shown in the drawing figures, to the skids 42. The deck 24 is supported on the skids 42 in the manner described below.

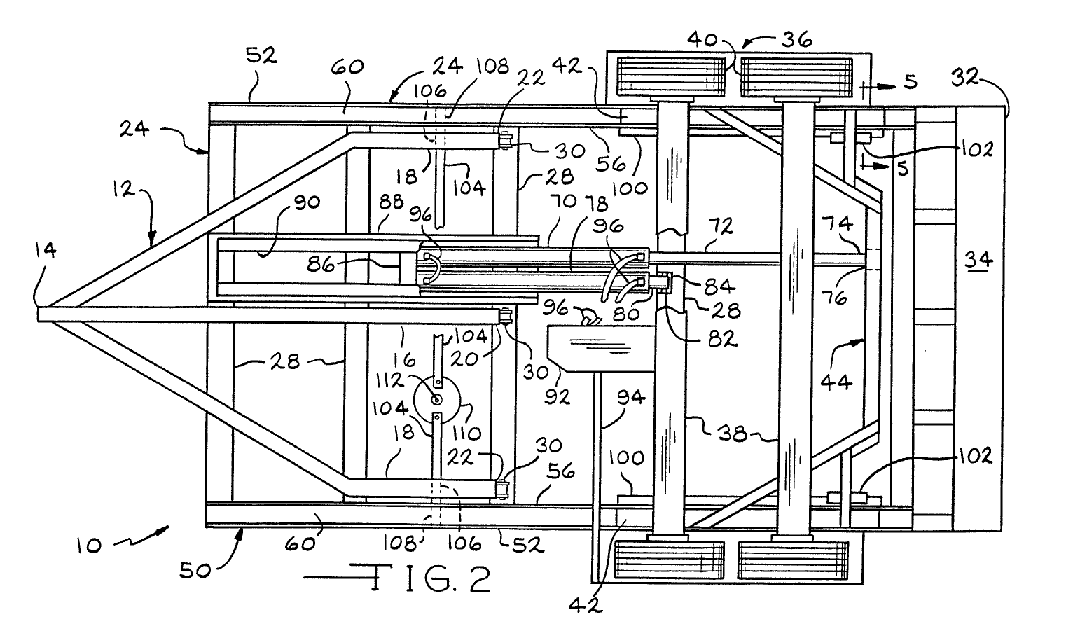

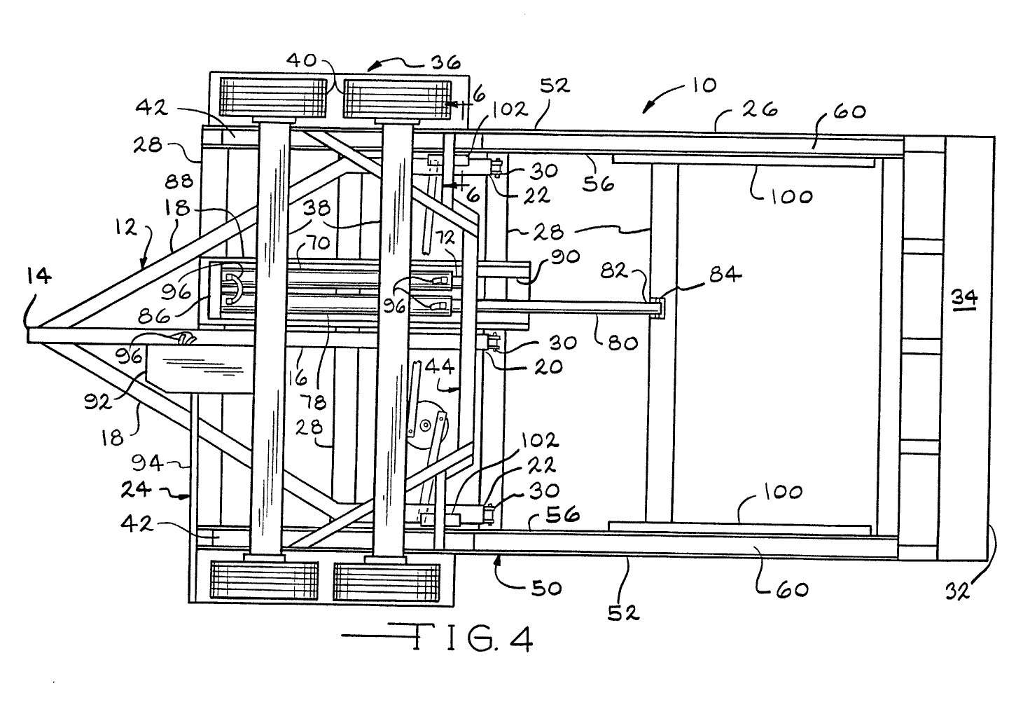

Skid runners 50 are secured to the underside of the deck 24 and, specifically, to the underside of the side rails 26. The skid runners 50 comprise U-shaped channel members which extend almost the entire length of the deck 24. Outer side walls 52 of the skid runners 50 cooperate with outer side walls 54 of the skids 42 to restrict lateral movement of the deck 24 relative to the axle carriage 36 and to maintain the deck 24 longitudinally aligned with the skids 42 of the axle carriage 36, as illustrated in FIGS. 2 and 4. Inner walls 56 of the skid runners 50 also cooperate with inner side walls 58 of the skids and also serve to restrict lateral movement of the deck 24 and to maintain the deck 24 longitudinally aligned with the skids 42 of the axle carriage 36. Either the outer side walls 52 of the skid runners 50 or the inner side walls 56 of the skid runners may be relied on, to the exclusion of the others, so that one may be eliminated with the remaining side walls operable to co-act with side walls of the skids 42 to restrict lateral movement of the deck 24 and to maintain the alignment of the deck 24 relative to the skids 42.

A connector wall 60 of the skid runners 50 is positioned over an upper wall 62 of the skids 42 and can rest thereon or, as shown especially in FIG. 5, the connector walls 60 of the skid runners 50 can rest on skid slides 64, comprising strips of polymeric material, especially materials with low coefficients of friction such as Teflon or high density polyethylene. The skid slides 64 can be secured to the skids 42, as shown in FIGS. 5 and 6 and they have lengths corresponding with the lengths of the skids 42. Alternatively, the skid slides could be secured to the connector walls 60 of the skid runners 50 and have a corresponding length. With or without the skid slides 64, the deck 24 is supported on the axle carriage 36 so that they may slide relative to one another in a longitudinal direction and lateral movement of the deck 24 relative to the axle carriage 36 is restricted.

A linear actuator is provided to effect sliding longitudinal movement of the axle carriage 36 relative to the deck 24 between a first, road position illustrated in FIGS. 1, 2 and 5, and a second, load position illustrated in FIGS. 3, 4 and 6. The actuator comprises a first hydraulic cylinder 70 with a reciprocating rod 72. A free end 74 of the rod 72 is secured to the frame 44 of the axle carriage 36 by a pivot connection 76 (FIG. 2). The actuator further comprises a second hydraulic cylinder 78 with a reciprocating rod 80. A free end 82 of the rod 80 is secured to a cross rail 28 of the deck 24 by a pivot connection 84. The ends of the cylinders 70 and 78, opposite the rods 72 and 80, are held in fixed relationship to each other and are secured to a slider assembly 86 which is supported in a slider channel 88 for longitudinal sliding movement therein. The slider channel 88 is secured to the deck 24 and, specifically, to the cross rails 28. The slider assembly 86 is supported within the channel 88 on support rails 90, portions of which are broken away in the drawing FIG. 2.

The cylinders 70 and 78, the rods 72 and 80 and the slider assembly are shown, in FIG. 2, in a first, road position. In FIG. 4, these elements are shown in a second, load position. In the first, road position, the rod 72 is extended from the cylinder 70, the rod 80 is retracted in the cylinder 78, and the slider assembly 86 is positioned towards the rear of the channel 88. In the second, load position, the rod 72 is retracted in the cylinder 70, the rod 80 is extended from the cylinder 78 and the slider assembly 86 is positioned toward the front of the channel 88. As the cylinders 70 and 78 are actuated to move the rods from the first position to the second position, they move the axle carriage 36, relative to the deck 24, from the first, road position shown in FIGS. 1 and 2, to the second, load position shown in FIGS. 3 and 4. As the axle carriage 36 moves from the first position to the second position, the skids 42 will pass a point where, due to the unsupported weight of the rear portion of the deck 24, the skids 42 can no longer support the deck 24 in a horizontal position. At that point, the deck 24 will pivot, relative to the drawbar 12, about the pivot connection 30, from the road position shown in FIG. 1 to the load position shown in FIG. 3. The deck 24 stops pivoting when the lower surface 34 of the deck 24, adjacent the rear edge 32, contacts the ground as shown in FIG. 3. At that point, forward portions of the skid runners 50 may lift up off of the skids 42 entirely and, in that case, rear portions of the skid runners 50 remain on the skids 42, as shown in FIG. 6. If the trailer is equipped with a single axle chassis, or if the trailer 10 is heavily loaded, or both, the skid runners 50 may remain squarely on the skids 42 or the skid slides 64 and one of the wheels will lift up off of the ground when the axle carriage is in the second, load position. With the deck 24 in the load position. it is oriented at a very slight angle to the ground so that equipment can be driven right onto the deck 24. Once equipment is on the deck 24, the cylinders 70 and 78 are actuated to move the axle carriage 36 to the first, road position and, during this movement, the axle carriage 36 and the skids 42 will pass a point on the deck 24 where, due to the unsupported weight of the forward portion of the deck 24. the deck 24 will pivot about the pivot connections 30 until it rests squarely on the skids and will be supported, thereafter, in the first, road position.

Actuation of the cylinders 70 and 78 is effected by a hydraulic fluid pump (not shown which is mounted in a pump housing 92, which, in turn, is secured to the axle carriage 36 and to an extended fender strut 94. Thus, the pump housing 92 travels with the axle carriage 36 although it could, alternatively, be secured to the deck 24. It is preferred to mount the pump housing 92 on the axle carriage 36, as shown, so that the pump (not shown) can be accessed easily when the axle carriage is in the second load position shown in FIGS. 3 and 4, where a portion of the pump housing 92 extends out beyond the edge of the deck 24. Hydraulic lines 96 provide a fluid connection between the cylinders 70 and 78 and the pump (not shown) and the pump can be actuated by a switch (not shown) which is preferably mounted on the axle carriage 36. The pump (not shown) is operable to deliver hydraulic fluid under pressure through the lines 96 to and through the cylinders 70 and 78, as needed, to effect the extensions and retractions of the rods 72 and 80 in the manner described above. Details regarding the hydraulic components, pumps, hoses and controls as they pertain to this preferred embodiment are well within the grasp and understanding of those skilled in the art and will not be further described herein. It will certainly be appreciated that other linear actuators may be incorporated in a trailer according to the invention in place of the illustrated actuator, including, but not limited to screw type actuators, chain drive actuators and cable actuators.

As described thus far, the deck 24 of the trailer 10 simply rests upon the skids 42 of the axle carriage 36. When the trailer is being used to haul a payload, however, a lock is desirable to lock the deck 24 to the axle carriage 36. An automatically engaging lock will now be described although it will be appreciated that a manual lock which requires some actuation, such as pushing a pin (not shown) through aligned openings (not shown) in the skid runners 50 and the skids 42, can also be used.

Deck lock members 100 comprising pieces of angle iron are welded, or otherwise secured, to the skid runners 50 and, specifically, to the inner side wall 56 of the skid runner 50. The deck lock member 100 has a length corresponding generally with the length of the skids 42. although they may be longer or shorter. Axle carriage lock members 102 comprising sections of C-channel are welded or otherwise secured to the axle carriage 36 and, specifically, in this embodiment, to the axle carriage frame 44, adjacent to the skids 42. The members 100 and 102 are positioned so that, when the axle carriage 36 is in the first, road position, as shown in FIGS. 1, 2 and 5, the members 100 and 102 engage, as clearly shown in FIG. 5, to maintain the skid runner 50 squarely on the skid 42 and to prevent the deck 24 from lifting off of the axle carriage 36. As the axle carriage 36 is advanced towards the second, load position, engagement between the members 100 and 102 will be maintained until the member 102 clears the member 100. This engagement, in the illustrated embodiment, continues over a distance corresponding roughly with the length of the member 100 and the trailer can be safely towed when the locking members 100 and 102 are within this locking range. Consequently, the position of the axle carriage 36 can be adjusted, within this range, all of which can be considered to correspond with the first, road position of the axle carriage 36, to vary the tongue or drawbar weight of the trailer 10, as desired, depending on the payload and its position on the deck 24. The locking members 100 and 102 are well out of their engagement range when the axle carriage 36 reaches a point where the deck 24 pivots down on the drawbar pivot connection 30 towards the load position, or up to the road position.

Due to the pivot connection 30 between the drawbar 12 and the deck 24, a force applied to the trailer 10 at the pivot connections could cause the cross rails 28 of the deck frame to lift off of the center bar 16 and the side bars 18 of the drawbar 12. Accordingly, it is preferred to provide a lock for locking the front end of the trailer to the drawbar when the deck 24 is in the first, road position. This locking connection must be releasable in order for the deck 24 to be able to pivot to the second, load position. Suitable locks include a lock rod or bar 104 (FIG. 2) which is received in a first opening, shown in phantom lines and indicated at 106, through the side bar 18 of the drawbar 12 and in a second opening, shown in phantom lines and indicated at 108, through the skid runner 50. The lock rods 104 can be just that, and they can be removed and replaced as needed to lock or unlock the deck 24 relative to the drawbar 12. Alternatively, the rods 104 can be connected to a plate 110 (FIG. 2) by pivot connections and the plate 110 mounted for rotation about an axis 112 so that, when it is in the position illustrated in FIG. 2, the rods 104 extend through the aligned openings 106 and 108. When the plate 110 is rotated ninety degrees from the FIG. 2 position, the lock rods 104 will be withdrawn from the openings 108 in the skid runners 50, as shown in FIG. 4. The plate 110 can be biased one way or the other and can incorporate old technology from garage door locking mechanisms including a handle for rotating the plate 110, and a détente lock or locks for maintaining the plate in a rotational orientation in which the lock rods 104 are withdrawn from, or extended into, the skid runners. Other suitable locks for releasably locking the deck 24 to the drawbar 12 may be used, too.

A second embodiment of a trailer according to the present invention is indicated generally at 200 and it will now be described with reference to FIGS. 7 through 13. The trailer 200 has some features in common with the trailer 10 and some uncommon features as well. It will be appreciated that one or more of the features of the trailer 200 may be substituted or combined with features of the trailer 10 and vice-versa.

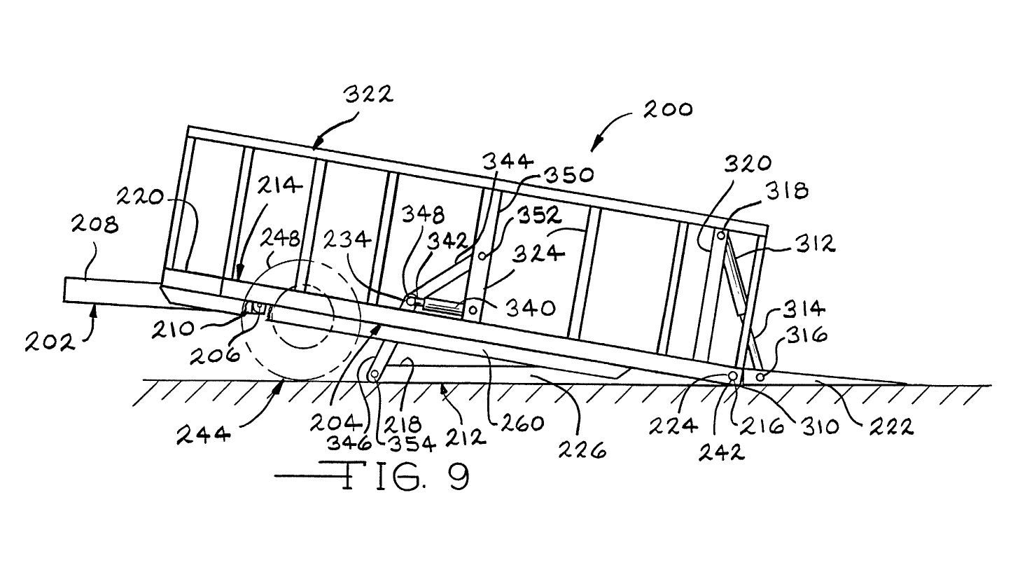

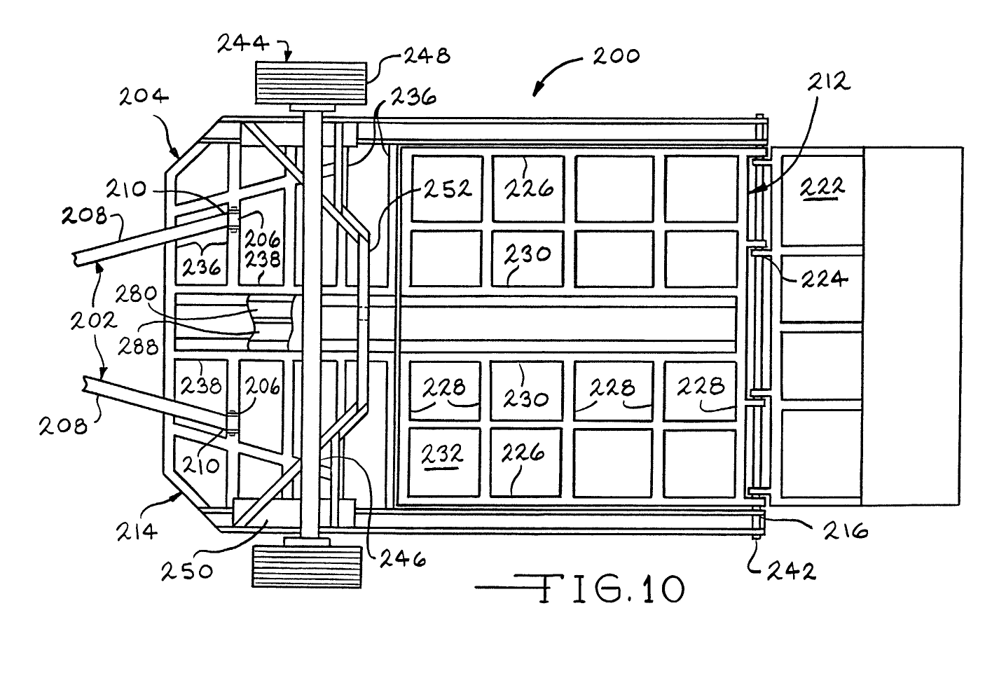

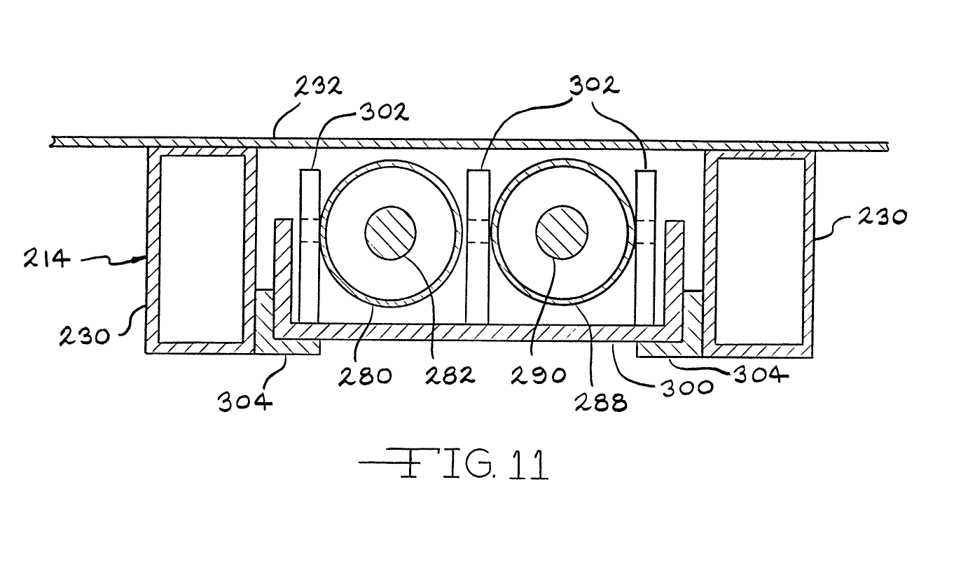

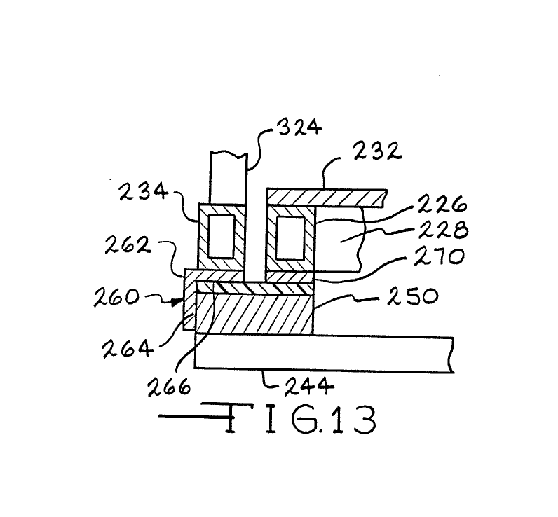

The trailer 200 comprises a drawbar or tongue, a portion of which is indicated at 202, for attaching the trailer 200 to a towing vehicle (not shown). The drawbar 202 comprises a two side bars 208. Ends 210 of the side bars 208 are connected to a deck, indicated generally at 204, by pivot connections 206. The deck 204 includes a loading deck, indicated generally at 212 (FIGS. 2 through 4) and a main deck indicated generally at 214. There is a pivot connection, indicated at 216, between the loading deck 212 and the main deck 214, at the rear of the trailer 200. The front of the loading deck 212, in certain circumstances, can pivot at 216 from a first, road position, illustrated in FIGS. 7, 8 and 12, where an upper surface 218 (FIG. 9) of the loading deck 212 is co-planar with an upper surface 220 of the main deck 214, to a second, load position, where it rests on the surface of whatever is under the trailer 200. A gate deck 222 is connected to the loading deck 212 and the main deck 214, by a pivot connection indicated at 224. The pivot connection 224 is coincident with the pivot connection 216 for economy and functionality, but they need not be coincident in order to achieve many of the objects of this invention. The gate 222, under certain circumstances, can pivot from a first, road position, illustrated in FIGS. 7 and 8, to a second, level loading position illustrated in FIGS. 9 and 10 and to a third, low loading position illustrated in FIG. 12.

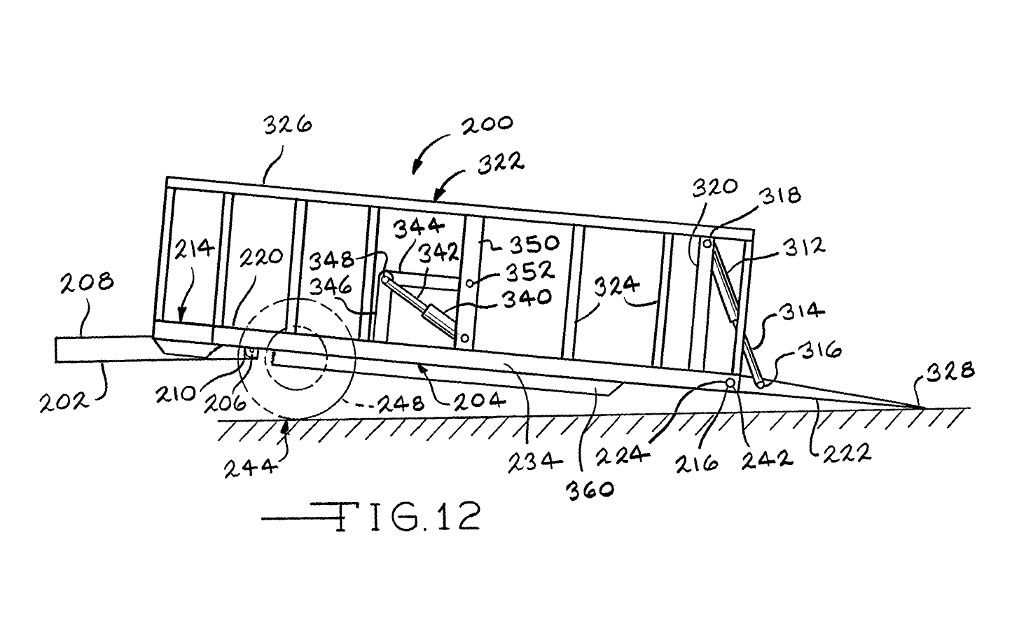

The loading deck 212 comprises outside rails 226, cross rails 228 and inside rails 230. The rails 226, 228 and 230, again, are preferably made of steel channel members which are welded together where they meet. The deck 212 can have any suitable configuration and, in this embodiment, constitutes a generally rectangularly shaped unitary structure comprising the rails 226, 228 and 230 which constitute a deck frame, and a deck bed 232 (shown in FIG. 11) secured to the frame by welding or other suitable means. Again, diamond steel plate is a preferred material for the deck bed 232.

The main deck 214 comprises outside rails 234, cross rails 236 and inside rails 238 connected where they meet. The outside rails 234 extend generally the length of the trailer 200. The outside rails 234 are connected to each other, at the rear of the trailer 10, by a pivot rod 242 connected between them. The loading deck 212 is pivotally connected to the rod 242 at the rear of the trailer 200. The loading deck 212 is sized to fit within an opening in the main deck 214 which is defined by the rod, 242, the main deck outside rails234 and the rear most cross rail 236 of the main deck 214.

The trailer includes an axle carriage indicated generally at 244. The axle carriage 244 illustrated in FIGS. 7 through 10 and 12 includes a single axle chassis, although an axle chassis with more than one axle may be provided in an axle carriage suitable for use in a trailer according to this embodiment of the invention. The axle chassis 244 comprises an axle 246 with a pair of wheels 248 supported on it. The axle carriage 244 further comprises a pair of skids 250 (see especially FIG. 13) which are secured, as by welding or the like, to the axle carriage 244. The skids 250 extend longitudinally of the trailer 200 and, preferably, as shown, are a little longer than the diameter of the wheels 248. The length of the skids 250 can be varied so long as they provide adequate support for the decks 212 and 214. The axle carriage 244 further comprises a frame, indicated generally at 252, which is secured by welding or the like, to the axle carriage. The decks 212 and 214, under certain circumstances, are supported on the skids 250, in the manner described below.

Referring now primarily to FIG. 13, skid runners 260 are secured to the underside of the deck 204 and, specifically to the underside of the outside rails 234 of the main deck 214. The skid runners 260 comprise angle iron members which extend almost the entire length of the deck 204, but terminate short of the rear of the deck 204. Outer side walls 262 of the skid runners 260 cooperate with outer side walls 264 of the skids 250 to restrict lateral movement of the deck 214 relative to the axle carriage 244 and to maintain the deck 214 longitudinally aligned with the skids 250 of the axle carriage 244, as illustrated in FIGS. 8 and 10. An upper wall 264of the skid runners 260 is positioned over the top of the skids 250 and can rest thereon or, as shown especially in FIG. 13, the upper walls 266 of the skid runners 260 can rest on skid slides 268, comprising strips of polymeric material, especially materials with low coefficients of friction such as Teflon or high density polyethylene, or the like. The skid slides 268 can be secured to the skids 250, as shown in FIG. 13. and they have lengths corresponding with the lengths of the skids 250. Alternatively, the skid slides could be secured to the upper wall 266 of the skid runners 260 and have a corresponding length. With or without the skid slides 250, the main deck 214 can be supported on the axle carriage 244 so that they may slide, relative to one another, in a longitudinal direction and lateral movement of the main deck 214, relative to the axle carriage 244, is restricted. The loading deck 212 and, specifically, the outside rails 234, are also supported on the skid slides 250. As shown in FIG. 13, the skid slide 250 extends towards the longitudinal centerline of the trailer 200 so that a portion of the skid 250 and the skid slide 268 is positioned directly under a portion of the outside rail 226 of the loading deck 212. A strap 270, which serves as a skid runner, is welded to the bottom of the outside rail 226 of the loading deck 212 and the strap 270 has a thickness corresponding with the thickness of the upper wall 266 of the skid runner 260 so that the skid runner 260 and the strap or skid runner 270 are supported on the skid slide 268 of the skids 250.

A linear actuator is provided to effect sliding longitudinal movement of the axle carriage 244 relative to the deck 204, and relative to the loading deck 212 and the main deck 214, between a first, road position illustrated in FIGS. 7 and 8, and a second, load position illustrated in FIGS. 9, 10 and 12. The actuator comprises a first hydraulic cylinder 280 with a reciprocating rod 282. A free end 284 of the rod 282 is secured to the frame 252 of the axle carriage 244 by a pivot connection 286 (FIG. 8). The actuator further comprises a second hydraulic cylinder 288 with a reciprocating rod 290. A free end 292 of the rod 290 is secured to the main deck 214 and, specifically, to the forward most cross rail 236 of the main deck 214, by a pivot connection 294. The cylinders 280 and 288 are held in fixed relationship to each other and are secured to a slider bracket 300 and, specifically, to bosses 302 which are secured to the slider bracket 300. The bracket 300 is supported in a slider channel formed in the loading deck 212 and the main deck 214, for longitudinal sliding movement therein. The slider bracket 300 is supported in the slider channel by angle iron members 304 which are secured to the inside rails 230 of the loading deck 212 and to inside rails 238 of the main deck 214.

The cylinders 280 and 288, the rods 282 and 290 and the slider bracket 300 are shown, in FIG. 8, in a first, road position. In FIG. 10, these elements are shown in a second, load position. In the first, road position, the rod 282 is extended from the cylinder 280, the rod 290 is extended from the cylinder 288, and the slider bracket 300 is near the center of the deck 204. In the second, load position, the rod 282 is retracted in the cylinder 280, the rod 290 is retracted in the cylinder 288, and the slider bracket 300 is positioned toward the front of the trailer 200. As the cylinders 280 and 288 are actuated to move the rods from the first position to the second position, they move the axle carriage 244, relative to the deck 204, from the first, road position shown in FIGS. 7 and 8, to the second, load position shown in FIGS. 9, 10 and 12. As the axle carriage 244 is moved from the first position to the second position, the skids 250 will pass a deck pivot point where, due to the unsupported weight of the rear portion of the deck 204, the skids 250 can no longer support the deck 204 in a horizontal position. At that point, the deck 204 will pivot, relative to the drawbar 202, about the pivot connections 206, from the road position shown in FIG. 7 to the load position shown in FIGS. 9 and 12. The deck 204 stops pivoting when a rear edge 310 of the deck 204, adjacent the pivot rod 242, contacts the ground as shown in FIG. 9. Before loading or unloading the trailer 200, the gate deck 222 is pivoted from the road position shown in FIG. 7 to a first, load position shown in FIG. 9 where the gate deck 222 rests on whatever is beneath the trailer 200.

A second linear actuator comprising a hydraulic cylinder 312 with a reciprocating rod 314 is provided to effect movement of the gate deck 222. The rod 314 is connected to the deck gate 222 by a pivot connection indicated at 316. The cylinder 312 is connected, by a pivot connection indicated at 318 to a frame member 320 which is supported on and secured to the outside rail 234 of the main deck 214. The frame member 320 is connected into a lattice which constitutes a side wall 322 and comprises vertical struts 324 and a top rail 326. The struts 324 are connected to the top rail 326 and to the outside rail 234 of the main deck 214. The side walls 322 serve to support the frame member 320, to strengthen and stiffen the outside rails 234 of the main deck and, although not shown, the side walls 322 are preferably covered to conceal the frame member 320, the actuator and so forth, for reasons of safety and aesthetics. It is preferred that two, second linear actuators be provided on the trailer 200, one on each side of the rear of the trailer 200.

The cylinder 312 and the rod 314 constituting the gate deck actuator are shown in a first, road position in FIG. 7 where the rod 314 is retracted and the gate deck 222 is in a first, road position where it extends upwardly and acts as a gate for the trailer 200. The cylinder 312 and the rod 314 constituting the gate deck actuator are shown in a second position in FIG. 9 where the rod 314 is extended and the gate deck 222 is in a second position where it rests on the ground or whatever is under the trailer 200. The cylinder 312 and the rod 314 constituting the gate deck actuator are shown in a third position in FIG. 12 where the rod 314 is extended past the second position and the gate deck 222 is in a third position in which an upper surface 330 of the gate deck 222 is co-planar, or substantially so, with the tilted upper surface 218 of the loading deck 212, and is co-planar, or substantially so, with the upper surface 220 of the main deck 214. In this position, a free end 328 of the deck gate is below the pivot rod 242, and below the pivot connections 216 and 224. The extension of the rod 314 beyond the second position lifts the rear of the trailer 200, adjacent to the pivot rod 242, off of the ground. With the trailer 200 in the condition illustrated in FIG. 12, i.e., the upper surface 218 of the loading deck, the upper surface 220 of the main deck 214 and the upper surface of loading deck 212, all in a substantially co-planar orientation, machines and equipment can be driven right onto and off of the deck 204. Once a payload is on the deck 204, the deck gate 222 is returned to the first position under the action of the actuator 312, the axle carriage 244 is returned to the first position under the action of the actuators 280 and 288, and the trailer 200, as shown in FIG. 7, is ready to roll. As the axle carriage is advanced towards the first position, it and the skids 250 pass a deck pivot point on the deck 204 where, due to the unsupported weight of the forward portion of the deck 204, the deck 204 will pivot about the pivot connections 206 until it rests squarely on the skids 250 and will be supported, thereafter, in the first, road position, on the skids 250. Due to the fact that the axle carriage 244 has a single axle chassis, the skid runners 260 will stay squarely on the skids 250 in all positions of the axle carriage 244. An axle chassis with more than one axle will resist rotation and, as noted above, in trailers according to the invention and having more than one axle, a portion of the skid runners may leave the skids as the axle carriage approaches the second, load position, while other portions of the skid runners remain on the skids.

The trailer 200 features virtually zero grade loading and unloading, as will be described below. The loading deck 212, as noted above, is connected to a pivot rod 242 by a pivot connection so that, under certain circumstances, the deck 212 can pivot from a first, road position, as shown in 7, to a second, load position shown in FIG. 9.

A third linear actuator comprising a hydraulic cylinder 340 with a reciprocating rod 342 is provided to effect pivoting movement of the loading deck 212 relative to the pivot rod 242. The rod 342 is connected to a frame strap 344 and to a deck strap 346 by a pivot connection 348. The frame strap 344 is connected to a frame member 350 by a pivot connection 352. The frame member 350 is connected to the top rail 326 of the side walls 322 and to the outside rails 234 of the main deck 214. The deck strap 346 is also connected to the loading deck 212 and, specifically, to the outside rail 226 of the loading deck 212, by a pivot connection 354.

The cylinder 340 and the rod 342 which constitute a loading deck actuator are shown in a first, road position in FIG. 7 where the rod 342 is extended and the deck strap 346 is operable to hold the loading deck 212 in the first position shown in FIG. 7. As noted above, in this first position, the upper surface 218 of the loading deck 212 is substantially co-planar with the upper surface 220 of the main deck 214. The cylinder 340 and the rod 342 are shown in a second position in FIG. 9 where the rod 342 is retracted and the loading deck 212 is in a second, load position where it rests on whatever is underneath the trailer 200. Thus, the only grade encountered by a vehicle being driven onto the trailer 200 with the loading deck 212 in the second position, is the grade of the gate deck 222 and this can be made to be very small. Alternatively, a ramp could be used in place of the gate deck 222. It is preferred that a pair of third actuators be provided for raising and lowering the loading deck, one on each side of the trailer 200. The deck strap 346 is sized to be received between main deck outside rail 234 and the loading deck outside rail 226 (see FIG. 13).

Actuation of the cylinder 340, again, is effected by a hydraulic fluid pump (not shown) generally in accordance with known principals of fluid hydraulics and will not be further described herein. It will certainly be appreciated that other linear actuators may be incorporated in a trailer according to this embodiment of the invention, in place of the illustrated actuator, including, but not limited to screw type actuators, chain drive actuators and cable drive actuators. The actuator 340 and associated components are preferably concealed within the side walls 322.

When the trailer 200 is being used to haul a payload, it is desirable to lock the deck 204 and, specifically, the main deck 214, to the axle carriage 244, as has been described above with reference to the trailer 10. Specifically, the trailer 200 may be equipped with a releasable locking mechanism to releasably lock the deck 204 to the drawbar 202 when the deck is in the first, road position.

In both described embodiments of a trailer according to the invention, axle carriages with full length axles have been described and illustrated. Previously, there have been attempts by others to carry out the objects of the present invention by incorporating opposed, disconnected, axle stubs in a trailer. Such attempts have not been very successful because the enormous stress and strain that such an arrangement places on the deck or whatever is supposed to support the axle stubs, cause problems. The present invention is particularly directed to achieving the objects of the invention with an axle carriage including an axle chassis with full length axles that extend across the width of the trailer. Instead of eliminating the axle entirely, in a trailer according to the present invention, the axle is simply moved out of the way by an actuator so that the deck of the trailer or portions of it can be lowered to the ground for loading or unloading equipment and the like. The axle carriage is then moved back into a road position where it supports the deck for towing. Although the decks disclosed herein are narrower than the distance between the wheels of the axle carriage, it will be appreciated that the present invention can be carried out in a trailer having a wider deck, i.e., one which is too wide to fit between the wheels so that it must be supported over the wheels for towing. In the embodiment shown in FIGS. 1 through 6, this would mean a higher load angle, other things being equal. In the embodiment illustrated in FIGS. 7 through 13, a virtually zero load angle can be achieved, even in a deck over the wheels trailer with full axles.

It will be appreciated that the foregoing detailed description of the preferred embodiments of the present invention are set forth in compliance with the requirements of the Patent Statutes and that the scope of the present invention is not limited thereto but only by the following claims.

I claim:

1. A trailer comprising
a drawbar for connecting the trailer to a towing vehicle
a deck,
a pivot connection between said drawbar and said deck,
an axle carriage comprising an axle chassis and skids connected to said axle carriage,
skid runners connected to said deck, said skid runners being operable to support said deck on said skids for sliding movement of said axle carriage, relative to said deck, between a first, road position in which a rear portion of said deck is supported over said axle carriage so that the trailer can be towed, and a second, load position in which said rear portion of said deck is unsupported and said deck is free to pivot about the pivot connection between said deck and said drawbar to a load position in which said rear deck portion rests on the ground, and
a linear actuator connected to said axle carriage and to said deck, said linear actuator being selectively operable to effect movement of said axle carriage, relative to said deck, between said first position and said second position.

2. The trailer claimed in claim 1 which further comprises skid slides positioned between said skids and said skid runners.

3. The trailer claimed in claim 1 which further comprises a lock for preventing said deck from lifting off of said axle carriage when said axle carriage is in said first, road position.

4. The trailer claimed in claim 3 wherein said first road position constitutes a range of positions and wherein said lock is operable, over said range, to prevent said deck from lifting off of said axle carriage.

5. The trailer claimed in claim 1 which further comprises a lock for selectively locking said deck to said drawbar.

6. The trailer claimed in claim 1 wherein said actuator comprises at least one hydraulic cylinder and extensible rod.

7. The trailer claimed in claim 1 wherein said deck comprises a frame and wherein said actuator is supported within a channel in said frame.

8. The trailer claimed in claim 1 wherein said deck further comprises a guide, wherein said axle carriage further comprises a guide, and, wherein, said axle carriage guide and said deck guide cooperate to restrict relative lateral movement between said deck and said axle carriage.

9. A trailer comprising
a drawbar for connecting the trailer to a towing vehicle,
a deck comprising a main deck and a loading deck and a pivot connection between them at the rear of the trailer,
a pivot connection between said drawbar and said deck,
an axle carriage comprising an axle chassis and skids connected to said axle carriage,
skid runners connected to said main deck, said skid runners being operable to support said main deck on said skids for sliding movement of said axle carriage, relative to said deck, between a first, road position in which a rear portion of said deck is supported over said axle carriage so that the trailer can be towed, and a second, load position in which said rear portion of said deck is unsupported and said deck is free to pivot about the pivot connection between said deck and said drawbar to a load position in which said rear deck portion rests on the ground,
a first linear actuator connected to said axle carriage and to said deck, said linear actuator being selectively operable to effect movement of said axle carriage, relative to said deck, between said first position and said second position, and
a second linear actuator connected to said main deck and to said loading deck, said second actuator being selectively operable to effect pivoting movement of said loading deck, relative to said main deck, about the pivot connection between them, between a first position in which an upper surface of said main deck is substantially co-planar with an upper surface of said loading deck and a second position in which a front edge of said loading deck is below the main deck and is resting on the ground.

10. The trailer claimed in claim 9 which further comprises a gate deck connected to said deck by a pivot connection and a third linear actuator connected to said gate deck and said deck, said third actuator being operable to effect pivoting movement of said gate deck between a first, road position, a second position in which a lower surface of said gate deck rests on the ground and a third position in which a rear edge of the gate deck is below said pivot connection between said gate deck and said deck.

11. The trailer claimed in claim 10 wherein, when said axle carriage is in said second position, it is entirely forward of said front edge of said loading deck.

12. The trailer claimed in claim 9 which further comprises skid slides positioned between said skids and said skid runners.

13. The trailer claimed in claim 9 which further comprises a lock for preventing said deck from lifting off of said axle carriage when said axle carriage is in said first, road position.

14. The trailer claimed in claim 13 wherein said first road position constitutes a range of positions and wherein said lock is operable, over said range, to prevent said deck from lifting off of said axle carriage.

15. The trailer claimed in claim 9 which further comprises a lock for selectively locking said deck to said drawbar.

16. The trailer claimed in claim 9 wherein said first, second and third linear actuators each comprises at least one hydraulic cylinder and an extensible rod.

17. The trailer claimed in claim 9 wherein said deck comprises a frame and wherein said first actuator is supported within a channel in said frame.

18. The trailer claimed in claim 9 wherein said deck further comprises a guide, wherein said axle carriage further comprises a guide, and, wherein said axle carriage guide and said deck guide cooperate to restrict relative lateral movement between said deck and said axle carriage.
